(19) United States
(12) Patent Application Publication
(10) Pub. No.: US 2005/0283427 A1
(43) Pub. Date: Dec. 22, 2005

(54) Automated trading system and software for financial markets

(75) Inventors: Joseph Scott Owens, Williamsburg, VA (US); Cord T. Awtry, Watertown, MA (US)

Correspondence Address: RR Law Firm;Attn: Paul L. Ratcliffe, Esq., 42870 Meander Crossing Court, Ashburn, VA, 20148, US

(73) Assignee: FX Engines, Inc.

(21) Appl. No.: 11/156,428

(22) Filed: Jun. 21, 2005

Related U.S. Application Data
(60) Provisional application No. 60/581,184, filed on Jun. 21, 2004.
(60) Provisional application No. 60/640,983, filed on Jan. 3, 2005.

(51) Int. Cl. G06F 17/60

(52) U.S. Cl. 705/37

(57) ABSTRACT

A redundant and hosted automated trading system and software for financial markets which allows price speculators to create fully automated or partially automated trading systems or engines using technical and fundamental data-driven triggers for market entry, exit, and trade management is provided. The automated trading system can reside locally on the user's computer or reside and is actuated in a remote, hosted, redundant computing environment. The system allows the trader to create fully or partially automated simple or complex conditions for market entry, market exit, and in-trade management which are then executed by the automated system on behalf of the trader. The system also enables users to automate their in-trade decisions through use of contextual exits which allow users to optimize each trade by mapping different strategies for each level. The system also enables users to create, manage, buy, sell, license, or provide automated trading processes, signals, or engines including selling automated signals or engines to other users for financial gain.

### RELATED APPLICATIONS

This application claims the benefit of U.S. Provisional Patent Application Ser. No. 60/581,184, filed on Jun. 21, 2004 and U.S. Provisional Patent Application Ser. No. 60/640,983, filed on Jan. 3, 2005 both of which are incorporated herein by reference in their entirety including all descriptions, figures, and appendices.

### FIELD OF THE INVENTION

The present invention relates to a method and system for automated financial transactions for financial markets and securities exchanges, including global exchanges for transactions in foreign exchange, commodities, equities, bonds, options, and other financial securities.

### BACKGROUND OF THE INVENTION

The financial services industry exists to allow two or more parties to exchange financial securities backed by either a corporate entity or commodity. These parties participate in the market either as buyers and sellers of securities in the normal course of their business, or as price speculators.

Currently, price speculators or traders must make their buy and sell decisions manually, based on a wide array of fundamental and/or technical data or parameters. Once these decisions are made, the trader must enter the market, manage the trade while it is in-the-market, and exit the market manually. Current software available to traders or users is non-automated, requires extensive user programming and is installed locally on the trader's computer. Such current systems have known user and system problems. Locally installed software is reliant upon the trader's computing and network connectivity redundancy. The high level of management needed to carry out these transactions is constantly challenged by limits of time, human capacity for consistent decision making, and scalable, redundant computing systems. Further, the non-automated applications currently available require extensive programming knowledge and system interaction to generate any type of trading system.

Therefore, what is needed is a system which automates the trading process allowing the user to create trading engines in a non-user programmed system which can be employed locally or through a remote, hosted, redundant, and scalable computing environment. Such a system will enable users to use a non-programming approach to pre-set conditions for market entry, trade management, and market exit. Once these conditions are in place, the system will carry out trades based on the pre-set conditions or parameters. All of these activities can take place locally or, in a preferred embodiment, in a hosted, redundant, scalable data center environment, allowing the trader to manage and monitor all activity from any computer with network connectivity, anywhere in the world. A hosted environment allows the additional benefit that the operation of the trading system would not be impacted by problems with the trader's computing equipment or network connectivity. However, the system of the present invention is not limited to a hosted environment and could be employed locally on the user's computer.

### SUMMARY OF INVENTION

The present invention provides a system which overcomes the obstacles described above by providing a non-user programmed software system for speculating in the price movements of all financial securities in either a locally employed platform or in a hosted, redundant, and scalable platform. The present invention also provides the user a simple, non-technical interface for the creation and management of conditions and tools for market entry, market exit, and trade management as opposed to the current user programming required systems. This unique invention allows traders to employ a locally employed system or communications network to connect to a remote, hosted, redundant software system to create or pre-set conditions for market entry and exit based on fundamental and technical data and to manage and monitor all trading activity.

Accordingly, it is a principal object of the present invention to provide a redundant and hosted system for users to create, employ, use, buy, and sell automated trading processes for the financial markets.

It is another object of the invention to provide an automated trading system for financial markets comprising at least one automated trading computer in communication with the Internet; at least one user computer in communication with the Internet; at least one financial market dealer computer in communication with the Internet; whereby a user through the user computer communicates with the automated trading computer to identify at least one parameter and at least one parameter trigger point for creating an automated trade process; where the automated trading computer, upon receiving the parameter and trigger point, monitors a plurality of real time data related to the parameter and when the trigger point is obtained the automated trading computer automatically communicates with a financial market dealer computer to execute the automated trade process. Still further, the parameter may be related to foreign exchange data. The automated trade process may be comprised of an entry order for entering a financial position, an exit order for exiting a financial position, an entry order for entering a financial position and an exit order for exiting a financial position, or at least one contextual exit order for exiting a financial position.

In addition, the system may comprise at least one database of a plurality of historical data related to the parameter for enabling the user to test the automated trade process against historical data. Further, the system may comprise at least one database of non-user created automated trading processes available to the user through the system of the present invention.

Still another abject of the invention is to provide a method of conducting an automatic trade through an automated trade system for financial markets comprising the steps of connecting at least one automated trading computer, in communication with a memory including a database defined by the memory, to a computer network for two way communication; communicating with a user computer connected to the computer network and providing a user interface for a user to create an automated trading process based on at least one trigger point of at least one parameter; saving the automated trading process in the database; monitoring a plurality of real time data related to the one parameter; and processing the automatic trade process when the trigger point of at least one parameter is obtained. A further step might include processing the automated trading process against a plurality of historical data related to the one parameter to determine historical performance perspective. In addition, the one parameter may be related to foreign currency exchange. The automated trading process may be comprised of an entry order for entering a financial position, an exit order for exiting a financial position, an entry order for entering a financial position and an exit order for exiting a financial position, and/or at least one contextual exit order for exiting a financial position. The invention may further offer at least one non-user created automated trading processes available for use by the user through the system of the present invention

Another object of the present invention is to provide a method of providing an automated trading system for financial market trading comprising the steps of providing a website on the Internet for access to the automated trading system, providing an interface for a user, accessible from the website, to create at least one automatic trading process based upon at least one trigger point of at least one parameter, providing a process for automated monitoring of the at least one parameter, and providing a process for executing the at least one automatic trading process when the at least one trigger point is obtained. Another step might include the step of processing the automated trading process against a plurality of historical data related to the at least one parameter to determine historical performance of the automated trading process. The method of the invention might provide that the at least one parameter is related to foreign currency exchange trading. Additionally, the automated trading process might be comprised of an entry order for entering a financial position, an exit order for exiting a financial position, an entry order for entering a financial position and an exit order for exiting a financial position, and/or of at least one contextual exit order for exiting a financial position. The invention might further include the step of providing a process for offering at least one non-user created automated trading processes available for use by the user through the automated trading system of the present invention.

These and other objects of the present invention will become readily apparent upon further review of the following specification and drawings.

### BRIEF DESCRIPTION OF DRAWINGS

FIG. 1A is a system diagram of the automated trading system according to the present invention.

FIG. 1B is an illustrative overview of the system architecture of the automated trading system of the present invention.

FIG. 2 is an illustrative overview of the different processes available to traders within the automated trading systems software of the present invention.

FIG. 3 is a process flow diagram of the automated trading system of the present invention.

FIG. 4 is screen capture of the automated trading engine creation user interface for a preferred embodiment of the present invention.

FIG. 5 is screen capture of the automated trading engine entry signal user interface for a preferred embodiment of the present invention.

FIG. 6 is screen capture of the automated trading engine creation exit signal user interface for a preferred embodiment of the present invention.

FIG. 7 is a process flow diagram of the automated contextual exits feature of the present invention.

FIG. 8 is screen capture of the contextual exits creation user interface for a preferred embodiment of the present invention.

FIG. 9 is a screen capture of the user interface for the automated trading signal creation for an MACD signal for a preferred embodiment of the present invention.

FIG. 10 is a screen capture of the automated trading engine historical trading data test user interface for a preferred embodiment of the present invention.

FIG. 11 is screen capture of the automated trading engine historical trading data test report user interface for a preferred embodiment of the present invention.

FIG. 12 is screen capture of the dashboard user interface for the automated trading system for a preferred embodiment of the present invention.

FIG. 13 is a screen capture for an order entry user interface for a preferred embodiment of the present invention

FIG. 14 is a screen capture for an exit signal creation user interface associated with the assisted trading function for a preferred embodiment of the present invention.

FIG. 15 is a screen capture for the managed engines user interface for a preferred embodiment of the present invention.

FIG. 16 is a screen capture for the managed engines detailed information user interface for a preferred embodiment of the present invention.

FIG. 17 is a screen capture for the managed signals user interface for a preferred embodiment of the present invention.

FIG. 18 is a screen capture for the managed signals detailed information user interface for a preferred embodiment of the present invention.

### DETAILED DESCRIPTION

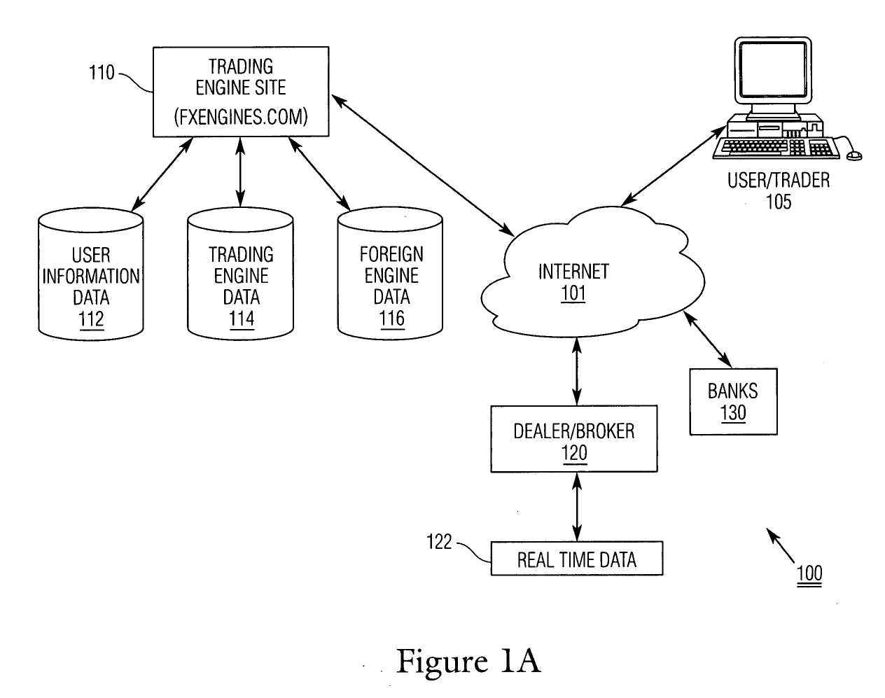

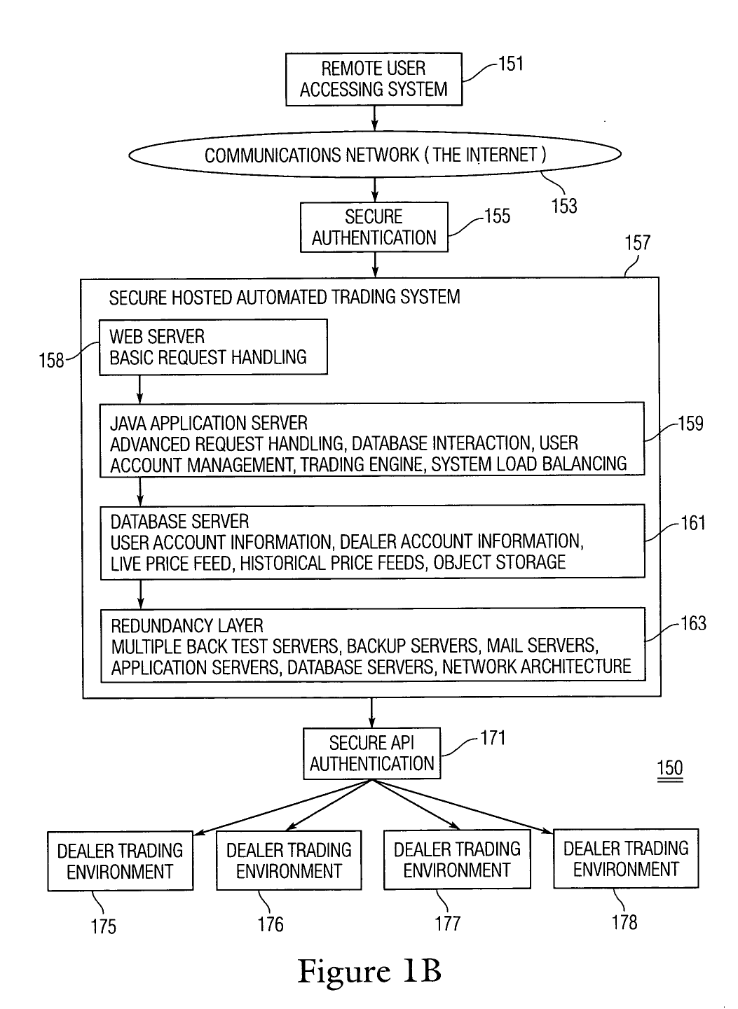

The system of the present invention will now be described in conjunction with FIGS. 1-18. The present invention provides a system which overcomes the obstacles described above by providing a system with the ability to allow traders to interact with an automated trading system in either a hosted or non-hosted environment.

Referring to FIGS. 1A and 1B, there is illustrated a diagrammatical representation of an automated trading system 100 for financial markets accessible on the internet 101 or as stand alone or embedded software. An internet website 110 (i.e. www.FXEngines.com) is connected to the internet 101 in two-way communication with prospective users or traders through their computer 105. The user 105 interacts with the Automated Trading website 110 to buy or sell positions such as foreign currency, stocks, mutual funds, or other investments. The Automated Trading site 110 is connected to various user information data 112, trading engine data 114, and investment data 116 (such as real time foreign currency exchange rates). The Automated Trading Site 110 may also be connected to a financial market dealer or broker 120 such as through a two way communication through the internet 101. The dealer 120 may also obtain and make available real-time data 122, such as market, financial, or exchange rate data, to the automated trading site 110. Further, Banks 130 or other financial institutions may be in communication with the Automated Trading Site 110 for retrieving real time financial market data, user account information, and for processing monetary, financial or trade related transactions.

As seen in FIG. 1B, the preferred embodiment 150 of the present invention employs a hosted version of the automated trading system 157 which operates within multiple tiers of computing that connect the trader 151 to the automated trading system 157, which is then connected to the various dealer trading environments 175, 176, 177, 178. Traders 151 access the system 157 via a communications network such as the Internet 153, securely authenticate 155, and interact with the system 157. For those systems where all conditions are set for actual live trading, the automated system 157 software securely interacts, via authentication 171, with the trader's dealer 175, 176, 177, 178 to execute entry and exit of trades on behalf of the trader 151. Within the preferred embodiment of the hosted automated trading system 157 there are 4 major elements: (1) web servers 158; (2) application servers 159; (3) database servers 161; and (4) redundancy components 163.

The web servers 158 provide the basic communication from the automated trading system 157 to the trader 151 making a request. The application servers 159 provide the application logic that drives the automated trading system 157. Elements from the users trading systems 151 are organized and executed according to all of the rules set forth by the trader during system creation. Additionally, the application sever 159 handles all interaction with the user's account and all connections to the database for retrieval of trader-specific and general data.

The database servers 161 provide storage for a wide array of data, including pricing data, historical pricing data, system configurations, user account configurations, system trading histories, trader-dealer configurations, and other data elements needed to ensure the smooth operation of the automated trading system. The redundancy components 163 provide all of the ancillary components needed to operate the automated trading system 157. These include network switches, routers, and firewalls, multiple historical back test servers, redundant price servers, database servers, and application servers, mail/communications servers, and other computing components required to maintain the secure, scalable, redundant, hosted environment of the automated trading system 157.

Together, the components of the preferred embodiment 150 of the present invention co-operate to allow the trader 151 to securely login 155 to the secure, hosted automated trading systems environment 157. Once the trader or user has logged in they can create and manage financial trading automated engines as well as manage their own account preferences. Once their systems are in place and their dealer account information is known, the system automates the user's entry and exit into the markets of their choice through the trader's specified dealer 175, 176, 177, 178, after authentication 171, freeing the trader from the previous constraints of time, human error, computing error, or other factors which often make non-hosted and non-automated trading systems incomplete and inefficient solutions.

As an example, consider a trader in the foreign exchange market who enters the market when the 20 period exponential moving average (EMA) crosses the 50 period exponential moving average and exits when he nets 100 points OR the two curves cross again, maintaining a 40 point “stop” during the trade. The trader from their system 151 would communicate through the internet 153 and obtain authentication 155 for logging into the remotely hosted automated trading system 157. Through their browser and the user interface screens of the present invention the user would create an automated signal for a 20 period EMA crossing a 50 period EMA, both for entry and exit. The trader would also create an automated signal for a 40 point fixed stop exit, and a 100 point limit exit. The trader would then combine the automated entry and exit signals creating an automated trading “engine” specifying the currency (USDJPY) and the trade direction (LONG). The user would specify his entry condition as EMA20/EMA50 cross, and then he would specify his exit condition as (a) when the 40 point stop was reached, (b) when the EMA20/EMA50 cross occurred again, or (c) when the trade reached +100 points. The user would save the automated trading engine and then activate it for testing or trading. The user could also test the automated trading engine over the past 4 years of historical data. Once satisfied with the engine's past performance and potential for future gain, he could activate the engine for live trading in the account he had previously specified as his live dealer account. The next time the EMA20/EMA50 cross occurred, his trade would be entered and the automated trading system would manage the trade to ensure that all exit conditions were monitored and acted upon when needed, until the trade was exited. This process would repeat for every cross of EMA20/EMA50, until the trader deactivated the engine or closed his account.

Through the system of the present invention, the trader can create automated trading signals and engines or systems based on fundamental or technical indicators for the foreign exchange, futures, or equities markets.

Although the preferred embodiment of the present invention provides a hosted system, the present invention could be employed locally on the user's computer. The user would locally install the necessary software components of the present invention which allow them to create and modify their trading engines based on fundamental or technical indicators or parameters for the foreign exchange, futures, or equities markets. Once the trading systems, schema, or engines are created locally the software application would interact with the user's dealer (broker) to complete the entry and exits of the trades. The present invention provides a user-friendly application with clear graphical user interfaces employed allowing the trader or user to make selections or input values for specific criteria related to entrance and exit rules established by the user in an environment which overcomes the obstacles of current systems which require user programming. Still further, the preferred embodiment provides a hosted system managed separately from the user's dealer. The software and system of the present invention could be embedded or employed on the dealer's own website or system.

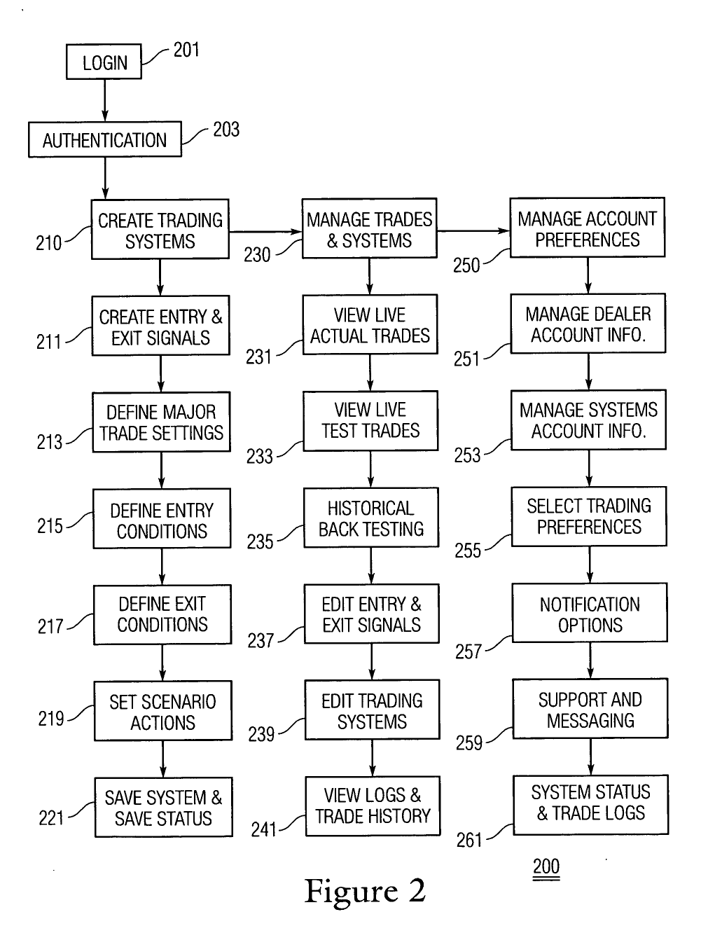

Referring now to FIG. 2, the user's interaction with the present invention provides a hosted and automated system 200 which includes several major functions or steps which include: (1) Login 201 and Authentication 203; (2) Trading Systems Creation 210, (3) Trading Systems Management 230; and (4) Account Preferences Management 250. Through the present invention, traders can create trading systems, manage trading systems, and manage account preferences.

The secure login 201 and authentication 203 component allows the user to access the system 200 remotely from anywhere in the world where a compliant communications network exists. Once the user provides login 201 and authentication 203 information, they are free to interact with the system 200 in a secure environment.

The automated trading systems are encapsulated in objects called trading “signals” or “engines”. Trading signals are automated actions for entry or exit into a financial position. A trading engine is one or more trading signals grouped together with other signals or a current financial position to automate the entry and/or exit of a financial position in the market. These trading engines contain all of the rules, conditions, and parameters specified by the trader for market entry, trade management, and market exit. Additionally, all “signals” may be created within the engine component, for further inclusion in engines either as entry triggers, exit triggers, or other trade management tools.

The user's interaction with the system 200 when creating an automated trading system 210 includes the steps of: (1) creating entry and exit signals 211; (2) defining any major trade settings 213; (3) defining any entry conditions 215; (4) defining any exit conditions 217; (5) establishing or setting any scenario actions 219; and/or (6) saving the automated trading system and setting its status 221.

Following the creation of a trading system, signal, or engine in steps 210-221, the trader can manage all active trading systems, signals, or engines in step 230. The trader can view live actual trades in step 231 or can test the automated trading systems or engines in step 233. Another beneficial aspect of the present invention is the user's ability to test the automated trading systems or engines over a historical period in step 235 to gauge their performance over time or under certain economic conditions. The trader can also elevate or initiate the status of a test system or engine to an actual live automated trading engine either through their account with a financial dealer or through the systems' 200 own trading capabilities. Still further, the user may edit saved entry and exit signals in step 237 or edit aspects of the trading systems or engines in step 239. The user may also view action and trading logs and history in step 241. Additionally, there are tools for the ongoing management, maintenance, and reporting of all trading systems and signals.

Another aspect of the system 200 is the Account Preferences Management component 250. Within this component 250 the trader can define and manage: (1) their dealer account information in step 251; (2) their automated trading system account information such as personal contact information in step 253; (3) their trading preferences such as type of currency and payment information for use of the service in step 255; (4) their notification options in step 257; (5) any support and messaging options step 259; and/or (6) any status or trade log information step 261. The system 200 might also provide a number of other settings for use within the automated trading system.

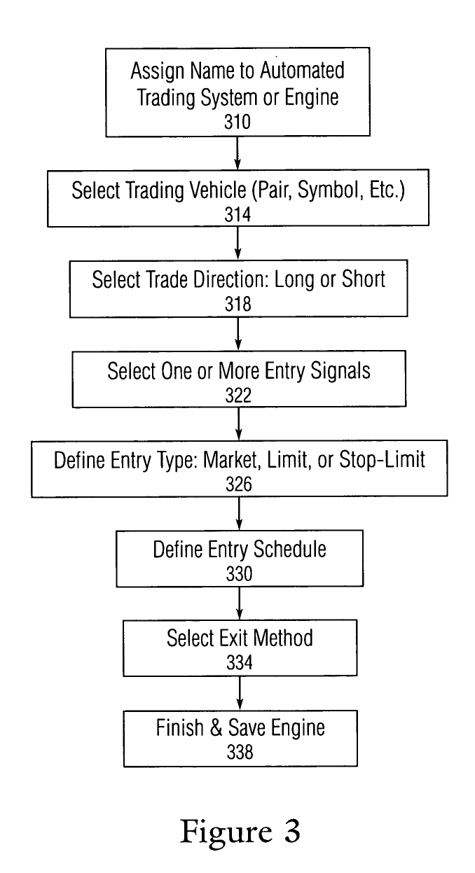

FIGS. 3-18 provide various flow diagrams and screen captures which set forth the user's interaction with the system of the present invention.

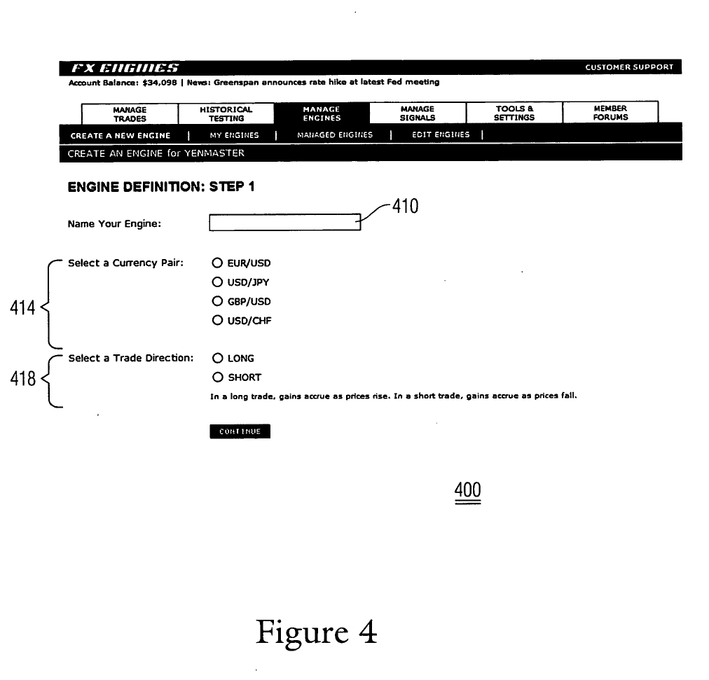

FIG. 3 provides a flow diagram for creating an automated trading system, signal, or engine. A user interacting with the present invention can create a trading engine such as for use in foreign currency exchange trading through the following process enabled by the present invention. First the user assigns a name to his engine in step 310. In step 314 the user selects their preferred trading vehicle which would include selection of the foreign currency pair or the two foreign currencies which will be exchanged. Next in step 318, the user will select the trade direction, which could be either long or short. An example of the graphical user interface screenshot 400 which allows the user to go through steps 310, 314, and 318 can be seen in FIG. 4. Window 410 is for entry of the engine name, user interface section n414 is used for selection of currency pair, and user interface section 418 is for selection of the trade direction.

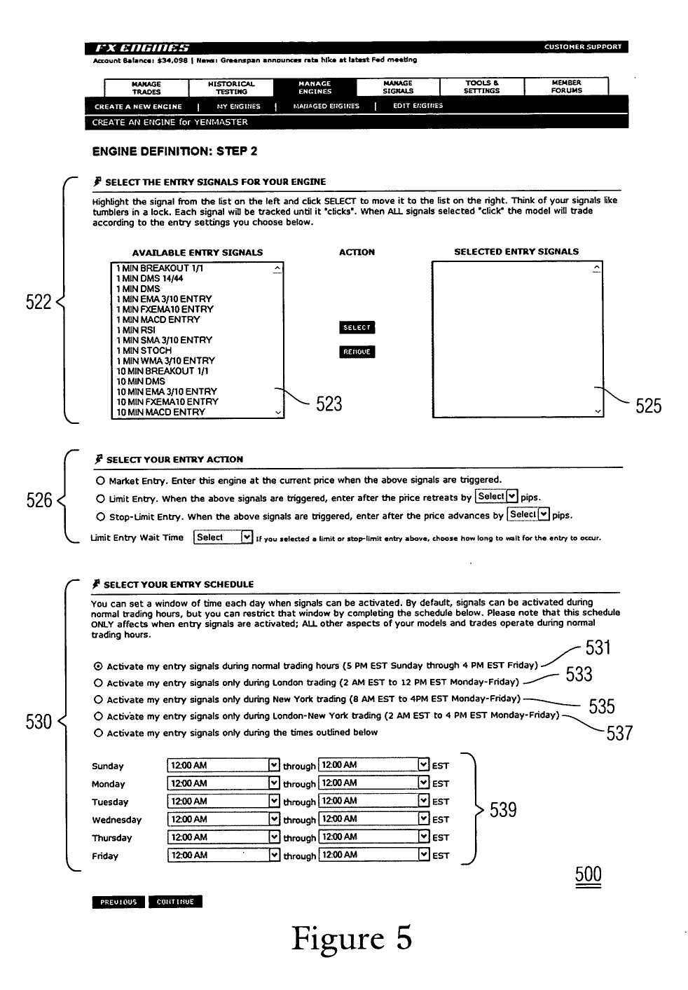

Steps 322-330 of FIG. 3 are selected by the user through user interface 500 depicted in FIG. 5. In step 322, the user selects one or more entry signals through user interface section 522. The entry signals are rules or hurdles which must be met prior to the trade processing. The available entry signals are displayed in window 523 and the signals selected for use by the user are displayed in the Selected Entry Signal window 525. For example, the user might select two entry signals with one signal based on the moving average and one based on a breakout. A breakout signal is a signal triggered by a change in price above or below the previous high or low price. Therefore, by selecting multiple entry signals the present invention would not initiate an entry transaction or trade until the criteria of both entry signals are met. For the example given above, both the moving average would have to meet a predetermined amount set by the user and the breakout signal would have to have been triggered.

In step 326, the user defines the entry type between a market entry, limit entry, or stop-limit entry. A market entry setting instructs the foreign currency exchange engine to enter at the current price upon the triggering of the entry signals. A limit-entry setting instructs the engine to enter the trade when the entry signals are triggered and the price has retreated by a predefined number of pips established by the user. The stop-limit entry instructs the engine to process the trade when the entry signals are triggered and the price advances by a preset number of pips. The user interface section 526 for defining the entry type is depicted in FIG. 5.

The user also defines the entry schedule in step 330 through user interface section 530. The entry schedule establishes a window of time when signals may be activated and trigger a transaction. The time windows may be established from a list of windows such as normal trading hours 531, London trading hours 533, New York trading hours 535, London and New York trading hours 537, or as specifically identified through user defined windows 539.

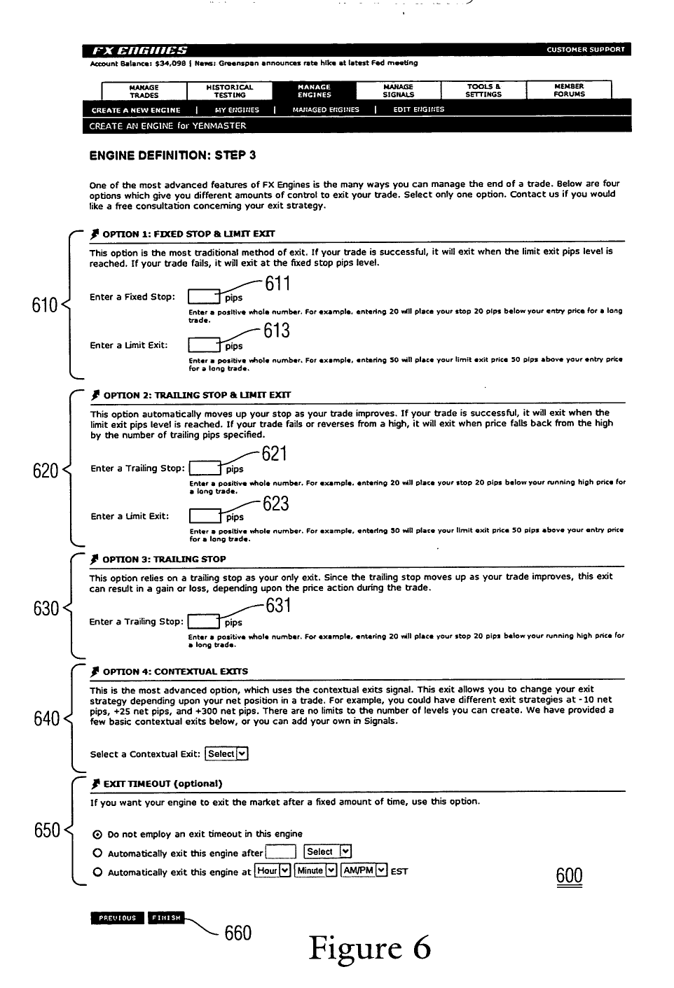

Once the user has selected and entered how they will enter the market they can establish the trigger points for when to exit their financial market transaction. The user, in step 334, selects from various exit methods available through the present invention. The user interface 600, depicted in FIG. 6, displays various exit methods available to the user. The user may select to employ a fixed stop or limit exit approach through interface section 610. The fixed stop approach allows the user to enter a number in window 611 which identifies how many pips above the entry price for a short trade or below the entry price for a long trade the user mandates before triggering an exit action. The limit exit approach allows the user to enter a number in window 613 which identifies how many pips above the entry price for a long trade or below the entry price for a short trade the user mandates before initiating an exit action. If the trade is successful, the engine will initiate the trade and exit only when the limit exit level is reached. If the trade fails, it will exit only when the fixed stop level is reached.

The user may also employ various other options, features, or elements as depicted in user interface 600 such as a trailing stop in combination with a limit exit 620, or a trailing stop alone 630.

Further, another novel aspect of the present invention is the employment of contextual exits which is depicted in user interface section 640 in FIG. 6. Contextual exits allow users greater flexibility in their trades enabling them to change their exit strategies depending on their net position in a trade. Therefore, the present invention allows users the flexibility to set forth different, varying, or layered exit strategies based upon the user's net position in a trade. For example, a user could have different exit strategies for a net position of −10 pips, plus 25 pips, or plus 300 pips. Contextual exits enable a user to set forth different exit trigger points for each level knowing their approach will vary based upon how successful or unsuccessful their trade has performed. Contextual exits will be described in more detail below. An additional exit strategy a user may employ is a time based exit through use of an exit timeout, as depicted in user interface section 650, in FIG. 6. The exit timeout 650 enables the user to exit their position after a fixed amount of time. Finally in step 338 of FIG. 3, the user can finish and save their automated trading system or engine by clicking the finish button 660.

As discussed above, Contextual Exits work by automating the decisions a trader makes during the course of a trade. Normally a trader will enter a trade and as the circumstances of the trade unfold, the trader's strategy will change to reflect market conditions. This application of “context” allows the trader to optimize each trade. Normally context is defined as the net position for the trade, but context can also include time or other technical and/or fundamental components. The trader uses the net pips ranges he believes are integral inflection points during the trade and maps different strategies to each level. Once completed, this contextual exit can be plugged into an automated trading engine where it is executed at each level by the trading platform of the present invention.

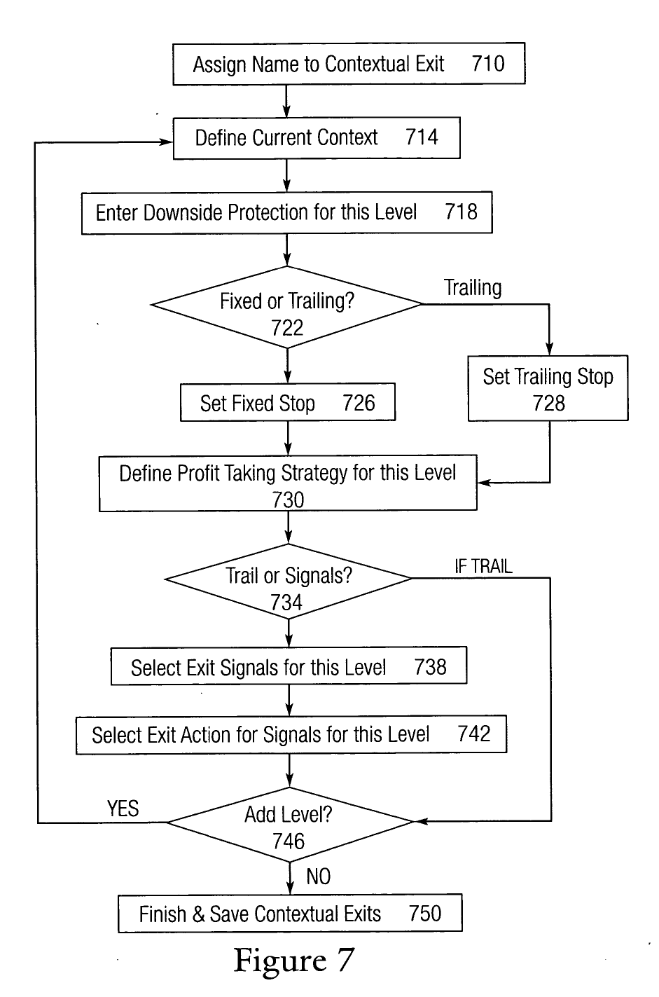

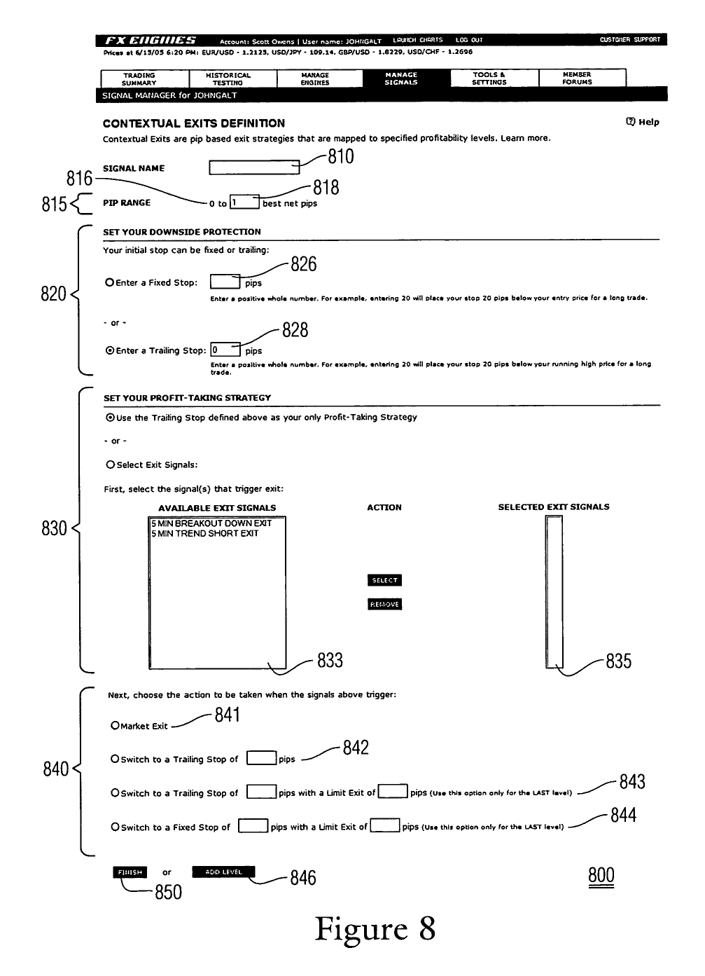

Referring next to FIGS. 7 & 8, the contextual exits feature, method and/or process will be described. For illustrative purposes the method will be described in conjunction with an example of a trader performing a financial market transaction related to trading foreign currency. The process for employing and establishing contextual exits for use with the automated financial trading system is illustrated in FIG. 7. A user interface for establishing the contextual exits is depicted in FIG. 8. As discussed above, a user may employ contextual exits as part of their exit strategy as shown in user interface 600 in FIG. 6. However, the user must first establish their contextual exits through the process provided in FIG. 7.

To establish contextual exits the user assigns a contextual exit signal name in step 710. The user enters the signal name in window 810 of user interface screen 800. In step 714 the user defines the current context or, as seen in user interface section 815, the pip range. The user enters the pip range in windows 816 and 818.

Once the contextual exit signal has been named and the pip range or current context has been defined the user may create or define their downside protection and profit-taking strategy for the named contextual exit signal. In step 718, as seen in user interface section 820, the user enters their downside protection. First the user must decide, step 722, whether they will use a fix or trailing stop downside protection approach.

If the user selects a fixed stop downside protection approach the user, in step 726, must set their fixed stop value by entering the pip value in window 826. The fixed stop value is a positive whole number, which sets forth the number of pips below your entry price for a long trade before the engine will signal to exit the transaction or trade. If the user selects a trailing stop protection approach the user, in step 728, must set the trailing stop value by entering the pip value in window 828. The trailing stop value is typically a positive whole number, which sets forth the pips below your running high price for a long trade before the engine will signal to exit the transaction or trade. Once the fixed stop or trailing stop value is set the user must then define their profit-taking strategy.

The profit-taking strategy, step 730, sets forth the rules by which the user is defining when they want the foreign currency exchange engine to exit the current transaction based upon reaching defined trigger points. In step 734 and as seen in user interface section 830 the user must select between a trailing stop and an exit signal approach. If the user selects the trailing stop approach the user may enter the trailing stop value in window 831. If the user, in step 734, elects to employ a signals based profit-taking exit strategy the user, in step 738, must then select the exit signals. As seen in user interface section 830, numerous exit signals are available for selection by the user in window 833. Once the user selects an exit signal they appear in the Selected Exit Signals window 835.

After selection of the exit signals the user, in step 742, will select the exit action for the signals. The selection of the exit actions for the signals is depicted in user interface section 840. In the preferred embodiment the user may select between a market exit 841, a trailing stop 842, a trailing stop with a limit exit 843, or a fixed stop with a limit exit 844. The user must also set the various values for the trailing stop exit approach 842, trailing stop with limit exit approach 843, and fixed stop with limit exit approach 844.

As the contextual exits feature of the present invention allows the user to apply multiple levels the user may, in step 746, add additional contextual exit levels. If the user elects to add additional levels the user will repeat steps 714 through 746 for the newly established context or pip range again through user interface 800. Adding additional contextual exits is accomplished by clicking the Add Level button 846. Through numerous iterations a user may establish a complex and multi-layered contextual exits engine for various pip ranges with varying levels of downside protection and profit-taking strategies. Upon completion of adding all levels of contextual exits, the user in step 750, can finish and save the contextual exit application they have created or established for current or future use. The user can finish adding contextual assets by clicking the Finish button 850.

As discussed above, the user may create automated trading signals which can be combined to form automated engines. Automated signals are events set or created by the user that trigger a trade entry or exit. Signals can be created using a variety of indicators or parameters common in market trading and foreign exchange trading. The various signal types can include Breakout signals, Contextual Exits, Directional Movement Systems, System Moving Averages, Moving Averages, MACD, Relative Strength Index, and Stochastic signals.

Breakouts are signals that trigger an entry or exit from changes in price, above or below a previous high or low. Breakouts occur when price exceeds prior lows or highs for a certain number of periods. Contextual exits are intelligent and layered trade exits as previously described above. They are pip based exit strategies that are mapped to specified profitability levels. Directional Movement System (DMS) signals use three different values to measure the momentum of trends and price moves. DMS is a momentum oscillator that utilizes the Directional Movement Index (DMI) and the Average Directional Index (ADX). Typical DMS signals might include the crossings of the DMI and ADX curves with each other, or the rising or falling of the ADX.

System moving average signals use the value of moving average slopes to determine when to enter or exit a trade. The system moving average is an advanced moving average derivative. The signal oscillates between positive values and negative values. In standard usage, positive values are long and negative values are short. Moving Average signals crosses of one moving average over another or the crossing of a moving average and price. Moving average signals are useful as Moving Average-Moving Average Crosses, Moving average—Price crosses, or as conditions.

Moving Average Convergence Divergence (MACD) is a common oscillating signal that may combine two or more different moving averages. Relative Strength Index (RSI) measures the strength of moves using a value that oscillates between 0 and 100. RSI is a momentum oscillator and typical signals are the reaching of specific levels. An RSI Divergence signal is created by pairing an RSI signal with a Breakout signal. Stochastic signals measure the levels at which price levels are overbought or oversold. Stochastic signals are price oscillators with typical signals occurring at crosses of % K and % D, or the reaching of specific levels for % K and % D.

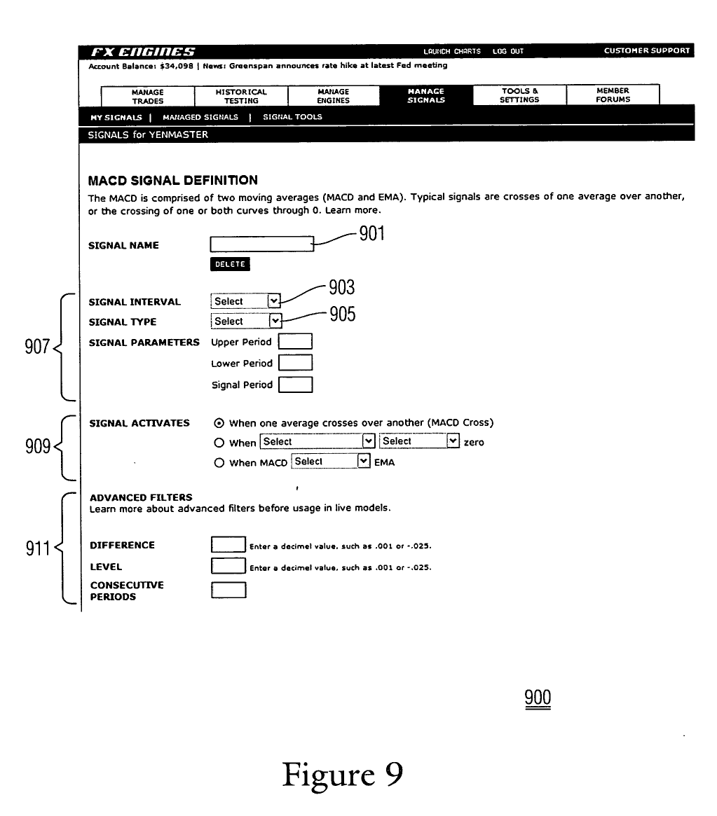

The system of the present invention provides appropriate user interfaces for creation of all automated signals described above. For exemplary purposes we will describe the user's interaction with the system in creation of an automated signal of the MACD signal type. As seen in FIG. 9, the user may be provided a user interface 900. The user interface 900 might describe the signal type. In this example, the MACD signal is comprised of two moving averages which are the MACD and the EMA. First the user would name the signal by entering a name in window 901. The user would enter the signal interval 903 and signal type 905. The user would also enter the signal parameters using user interface section 907 and the signal activates through user interface section 909. The user may also apply advanced filters through user interface section 911. Through use of user interface 900, a user can create an automated MACD signal. The system of the present invention also provides user interfaces for the creation of the other mentioned automated signals types including: Breakout signals, Contextual Exits, Directional Movement Systems, System Moving Averages, Moving Averages, Relative Strength Index, and Stochastic signals.

Automated Engine Testing

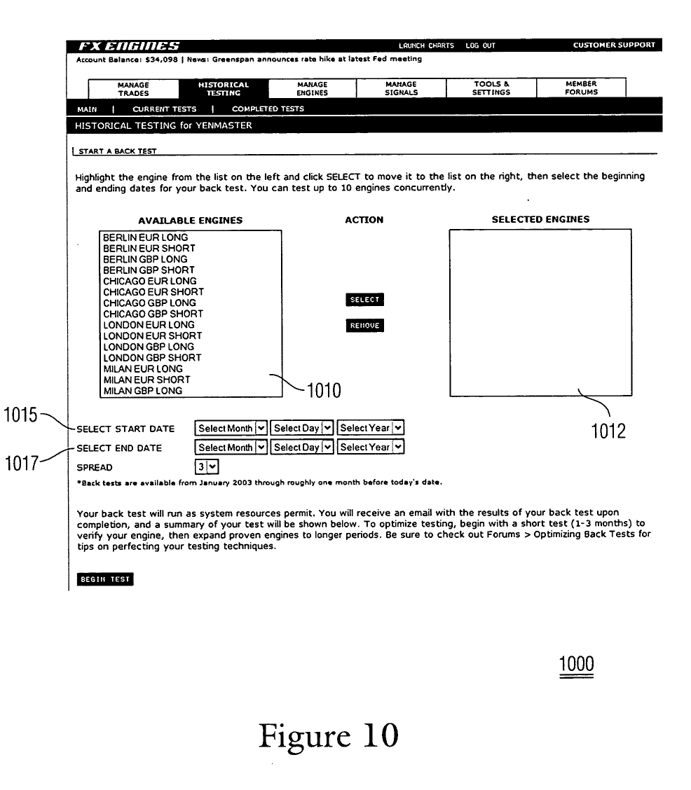

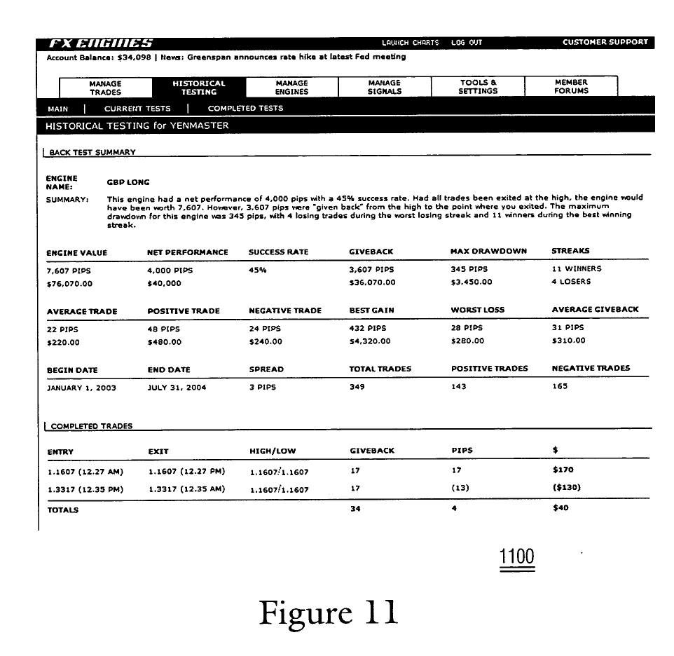

An additional feature of the present invention, as depicted in FIGS. 10-12, allows the user to test their automated trading engines against historical and real time data. As seen in user interface 1000 in FIG. 10, the user may select engines from the available engines window 1010. Selected engines are displayed in the selected engines window 1012. The user also selects the historical data start date through interface 1015 and the end date through interface 1017. This allows the user to test whether the automated trading engine they created would have been successful if employed retroactively. The historical testing gives users the ability to gauge the potential success rate of their engine for future occurrences. Historical data testing will also help users identify the conditions under which their engine did or did not perform well so that they might make refinements to their trading engine. In addition, users may test their engines against a multiplied historical test. The results of the automated trading engine test are displayed to the user. An example of the historical data test results for a foreign exchange automated trading engine are provided in a test summary report 1100 as seen in FIG. 11.

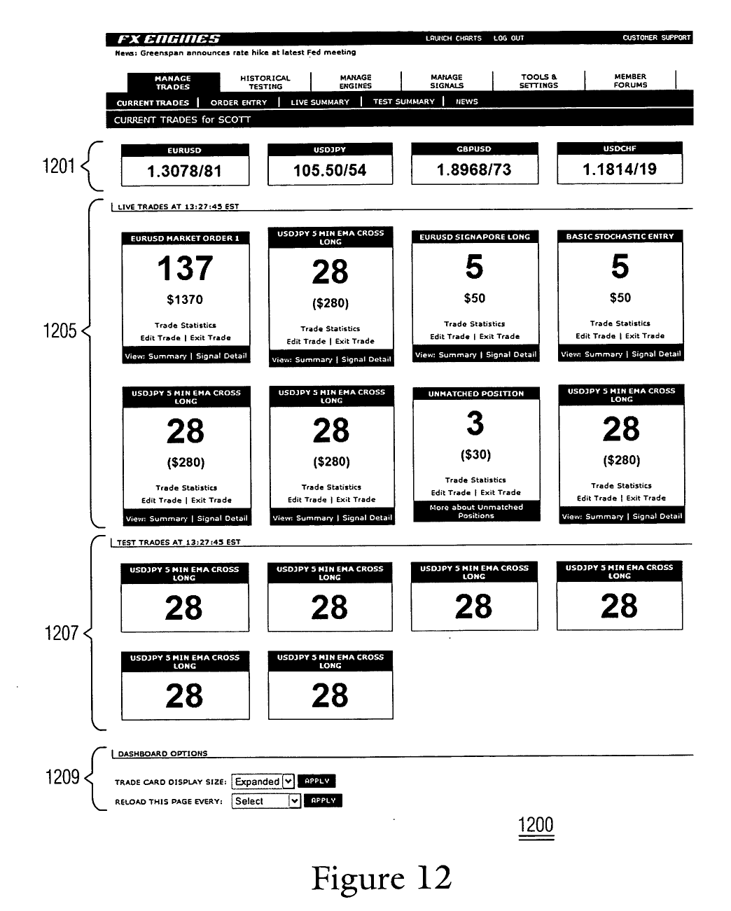

The system of the present invention also allows the user to run their automated engines against real time/live trading data to determine the engines effectiveness or success in a real time setting. The results of the real time automated trading engine test are displayed to the user as will be further described in conjunction with FIG. 12. The features of the present invention enable the user to test an engine, such as a foreign exchange trading engine, prior to risking financial loss. Ultimately, once a user is satisfied with an engine and wants to employ it with real transactions the user can do so through their dealer or through a dealer associated with the system.

Through the system of the present invention the user is able to employ a computerized automated trading system for financial markets. The system is ideally suited for trading in foreign currency where a user can create, test and initiate automated foreign currency exchange trades employing various entry and exit signals and engines through easy user interface forms. The user interface forms allow the user to create customized trade entry and exit triggers or criteria.

As seen in FIG. 12, the user can manage their financial market trades through user interface screen 1200 or what is often referred to as a dashboard. Through the dashboard 1200 the user can view real time foreign currency rates 1201, real time positions in live trades 1205, real time positions for test trades 1207, and select several options 1209 related to the dashboard 1200. Through the user interface dashboard 1200 and other user interfaces of the system of the present invention the user can easily and effectively manage, create, test and conduct live automated trades in the financial market.

Still further, the present invention allows the user to create and implement layered exit strategies through the use of a contextual exit environment resulting in layers of trade context. The graphical user interface screens of the present invention enable the user to create the automated trading signals, engines and contextual and layered exits through the selection of pre-set options with user input values. Through the present invention the user may determine which exit actions to take for each contextual level. The system of the present invention may be employed as a test against historical or live data, may employ both the trading engine and contextual exit concepts and may integrate with or connect to the trader or user's dealer (and associated user account) or a dealer associated with the system of the present invention.

Another aspect of the present inventions pertains to the systems ability to enable users to employ assisted trading. For a variety of reasons, some traders prefer manual trading over automated trading. Some user's trading systems may not be suited for automatic trading or they may want to actively manage every transaction as opposed to allowing the system of the present invention to control their trades and account. However, the 24 hour nature of trading in the various markets, including foreign exchange trading or forex, results in physical challenges these traders have difficulty overcoming. For these traders, the present invention provides assisted trading. Assisted trading allows the trader to use whatever amount of automation needed to affect their trading goals. The toolkit provided through Assisted Trading allows the trader to do any of the following: (1) manually enter trades and then implement automated exit strategies; (2) automatically enter trades and implement manual exit strategies; and (3) manually enter and exit trades with manual revisions mid-trade.

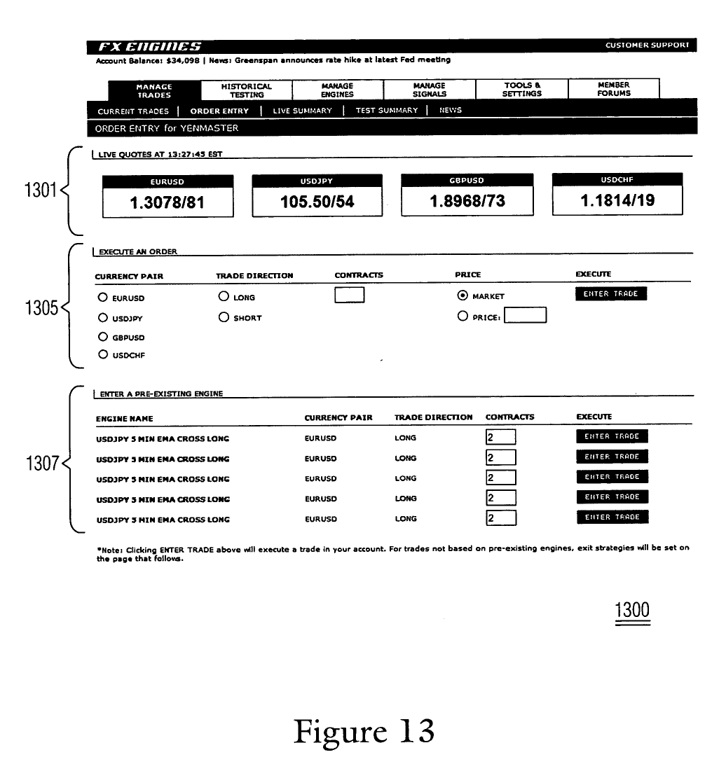

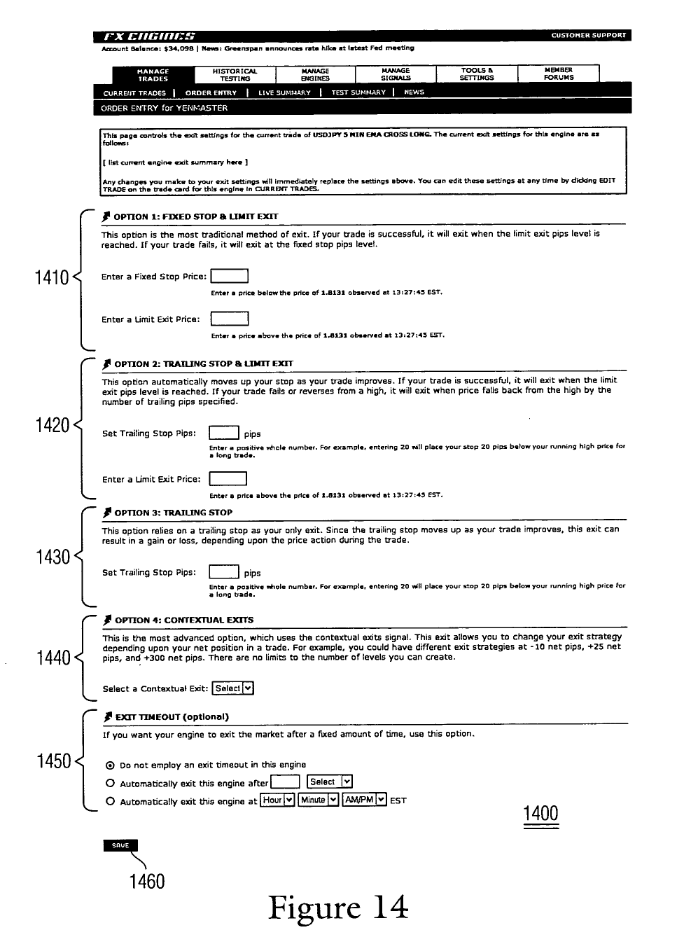

Assisted trading gives a trader the ability to place discretionary orders but leave the execution of those orders, which can be complex, to an automated trading platform. For example, as seen in user interface 1300 in FIG. 13, the trader could choose to manually open a trade using either a market order or an order at a specific price through user interface section 1305. The user can see real time pricing or currency exchange rates through user interface section 1301 or can use a pre-existing automated engine to enter the market as seen in user interface section 1307. Now that the trader has entered the market and has a position they can specify the exit strategy. Consistent with the discussion related to FIG. 6 and as seen in user interface 1400 in FIG. 14, the user can employ a fixed stop and limit exit 1410, a trailing stop and limit exit 1420, a trailing stop 1430, any contextual exits 1440, or an exit timeout 1450.

Once in the market, the trader can leave the original exit strategy in place or edit the trade to insert a new exit strategy. Thus, the trader can observe market forces and make mid-trade strategy changes that result in optimized transactions. Ultimately, the assisted trading feature of the present invention allows a user to implement a partially automated trade where the user might manually perform some of the functions for financial market trading but establish automated signals or functions for controlling other aspects of the financial market trading.

The preceding descriptions of the present invention disclose a system which enables a user to establish their own entry and exit strategies employing a fully or partially automated trading system. However, the present invention also allows the users to make their automated trading systems, signals, and engines available to others. As some traders may have better or more successful engines there might be a market for those traders to license, sell, rent, or make their engines available for others to use. Therefore, the system of the present invention enables users to create, offer, sell, license, buy, and/or use managed engines or signals.

Managed Engines

The present invention enables users or the administrators of the system to create automated trading engines which are made available to other users. The automated trading engines available are called managed engines. The managed engines may be made available to other users for a fee. The fee to use the automated trading engine may consist of a one time fee, a per trade fee, an upfront fee with a per trade fee, or any other appropriate fee based approach. The fee could go to the creator, the company running the system, or be split between the company running the system and the creator.

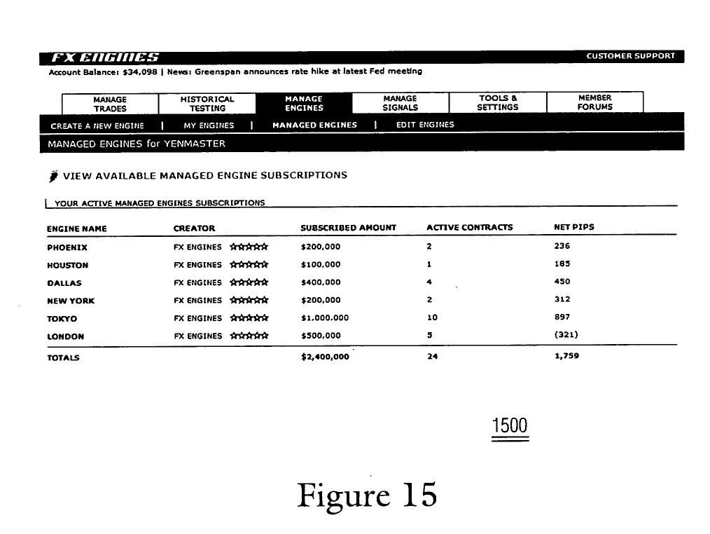

In order to match traders with good trading systems, the present invention provides an automated trading systems marketplace where traders can buy and sell complete systems. As seen in FIG. 15, the automated trading systems or managed engines may be listed on a user interface 1500 along with relevant information and statistics. The trader will be able to see who is offering the Managed Engine, what their user feedback rating is, the subscribed amount or how much they can trade using the particular engine, the number of active contracts, and its net performance to date.

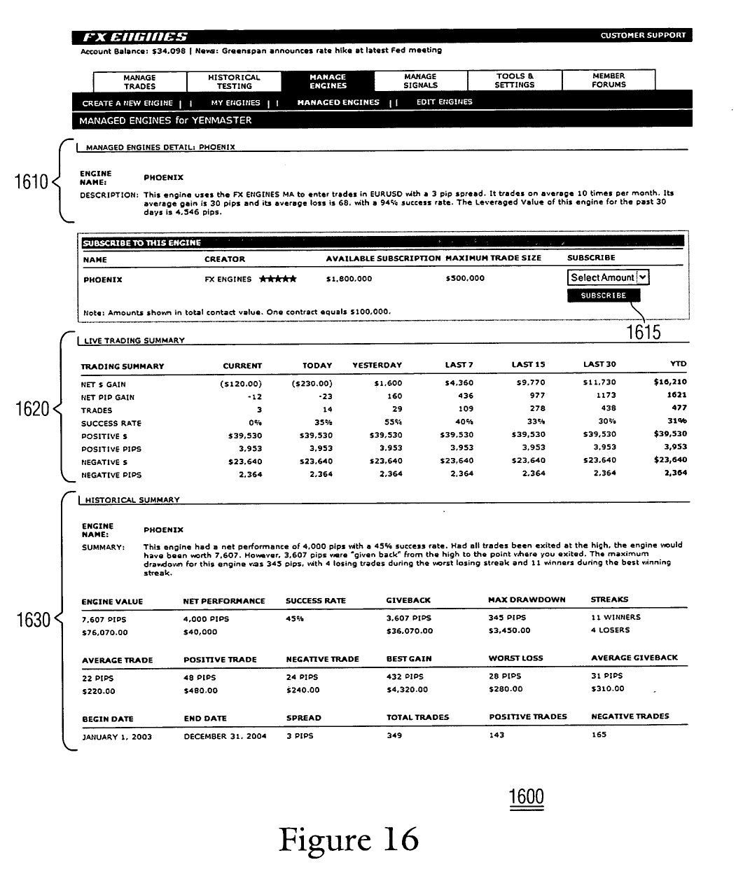

Upon further inspection, the trader can see a few more details about a specific managed engine. As seen in FIG. 16, user interface 1600 provides the prospective automated engine buyer a more detailed view of the engine's performance including a description 1610, a live trading summary 1620, and a historical trading summary 1630. The trader can ‘subscribe’ to the engine at this point by selecting button 1615.

Once subscribed, the trader will have the use of the managed engine just like any other engine they may have created on their own or already purchased or licensed through the managed engine function. Parts of the engine may be kept hidden from the acquiring trader to prevent duplication and redistribution. If the trader ever ‘unsubscribes’ from the managed engine, the amount of available subscription will be re-released making the amount available to all other users or traders of the system of the present invention.

The available subscription amount and maximum trade size may be set by the automated engine creator or a system administrator and is primarily intended as a cap so as not to affect performance. For example, if too many contracts are being bought or sold at once, the ability for all subscribers of an engine to get the same positions would be adversely affected. Therefore, the creator of the automated engine or a system administrator may determines how many contracts can be traded in each automated system to allow it to trade at the highest number of contracts without affecting performance.

In addition to the managed engines marketplace, the present invention may also combine a number of managed engines into one or more packages and make them available for subscription as a portfolio or combination. The combined packages might enable users to increase their available engines to take advantage of different market conditions, different trades or exchanges.

Managed Signals

Still further, although some traders have ideas on how to enter (or exit) a trade they may be missing the corresponding exit (or entry) to create a complete automated trading engine. Since an automated engine is the combination of one or more automated signals, the trader may desire to obtain a better or different automated signal for combining with the signals he already has.

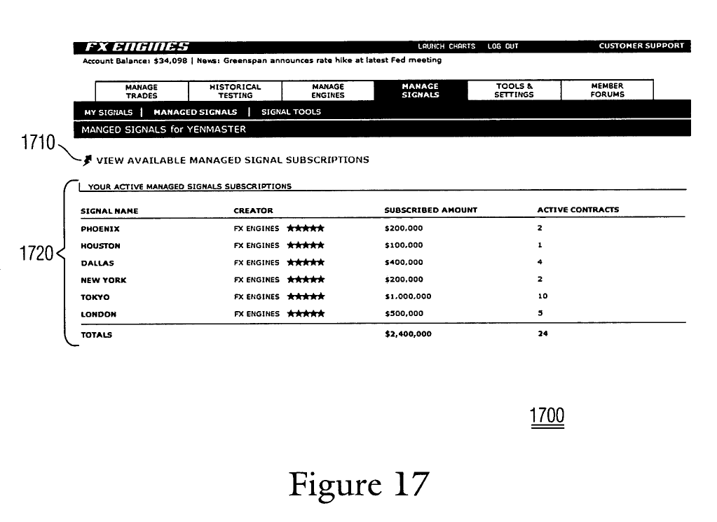

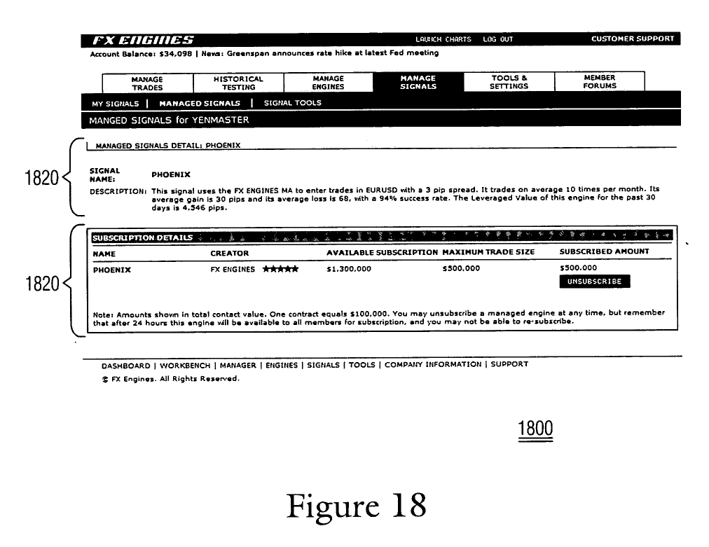

In order to match the trader with better or available signals, the present invention enables users to create, offer, sell, license, buy, and/or make available for use automated trading signals. As seen in FIG. 17, user interface 1700 provides a link to available managed signals 1710 as well as a list of the user's available automated trading signals or managed signals 1720. When a user selects a managed signal they are provided further information on the managed signal as depicted on user interface 1800 in FIG. 18. The additional information might include a managed signal description 1810 as well as the subscription details 1820.

Like the managed engines, the managed signals may provide signal names, creators, creator ratings, subscribed amounts and the number of active contracts. Through the automated trading signal or managed signal marketplace traders with good signals, or signal providers whose business it is to create and distribute signals for profit, can license signals to other traders who need to find better signals for monetary gain. The trader selling or licensing the managed engine or signal could receive a payment related to the trading activity of the trader purchasing or receiving the license. Once again, the fee could go to the creator, the company running the system, or be split between the company running the system and the creator.

Although the present invention is intended to enable users to create and offer managed signals and engines for a fee the system and method of the present invention could enable the users to offer their signals and engines to others without compensation. Once subscribed, a trader can take one or more signals and combine them into his own engines for use in trading. If the trader ever unsubscribed from the managed signal the managed signal's allotment of the authorized subscription amount would be made available to other users immediately.

Therefore, the present invention provides an automated trading system for financial markets which enables user to fully automate or partially automate both the entry and exit of financial transactions. The present invention also enables user to add contextual exits to automated trades adding layers of automated action to the automated engines based on multiple factors. The present invention also provides a platform or marketplace for users to create and sell or license automated signals and/or automated engines for others to use. The present invention is ideally suited for use in foreign exchange market transactions. Users, may test engines with real time data, historical data, and may conduct live trades through the system of the present invention either directly or through the user's dealer. The system may be stored locally on the user's computer, remotely hosted, including redundancy of the system components for insuring monitoring and trading of the automated engines, or could be embedded in the trading systems of dealers or brokers.

In addition to above describe applications and features, the automated trading system could be used for non-standard, custom, and/or advanced indicators such as neural networks or artificial intelligence systems to automatically execute trades in financial markets worldwide.

It is to be understood that the present invention is not limited to the embodiments described above, but encompasses any and all embodiments within the scope of the following claims.

1. An automated trading system for financial markets comprising:
at least one automated trading computer in communication with the Internet;
at least one user computer in communication with said Internet;
at least one financial market dealer computer in communication with said Internet;
whereby a user through said at least one user computer communicates with said at least one automated trading computer to identify at least one parameter and at least one parameter trigger point for creating an automated trade process;
said automated trading computer, upon receiving said at least one parameter and said at least one parameter trigger point, monitors a plurality of real time data of said at least one parameter;
wherein when said at least one parameter trigger point is obtained, said automated trading computer automatically communicates with said at least one financial market dealer computer to execute said automated trade process.

2. The system of claim 1, wherein said at least one parameter is related to foreign exchange data.

3. The system of claim 1, wherein said automated trade process is comprised of an entry order for entering a financial position.

4. The system of claim 1, wherein said automated trade process is comprised of an exit order for exiting a financial position.

5. The system of claim 1, where said automated trade process is comprised of an entry order for entering a financial position and an exit order for exiting a financial position.

6. The system of claim 1, wherein said automated trade process is comprised of at least one contextual exit order for exiting a financial position.

7. The system of claim 1, further comprising at least one database of a plurality of historical data related to said at least one parameter for enabling said user to test said automated trade process against said plurality of historical data.

8. The system of claim 1, further comprising at least one database of at least one non-user created automated trading processes made available for use to said user through said at least one automated trading computer.

9. A method of conducting an automatic trade through an automated trade system for financial markets comprising:
connecting at least one automated trading computer, in communication with a memory including a database defined by the memory, to a computer network for two way communication;
communicating with a user computer connected to said computer network and providing a user interface for a user to create an automated trading process based on at least one trigger point of at least one parameter;
saving said automated trading process in said database;
monitoring a plurality of real time data related to said at least one parameter; and
processing said automatic trade process when said at least one trigger point of at least one parameter is obtained.

10. The method according to claim 9, further comprising the step of processing said automated trading process against a plurality of historical data related to said at least one parameter to determine historical performance perspective.

11. The method according to claim 9, wherein said at least one parameter is related to foreign currency exchange

12. The method according to claim 9, wherein said automated trading process is comprised of an entry order for entering a financial position.

13. The method according to claim 9, wherein said automated trading process is comprised of an exit order for exiting a financial position.

14. The method according to claim 9, where said automated trading process is comprised of an entry order for entering a financial position and an exit order for exiting a financial position.

15. The method according to claim 9, wherein said automated trading process is comprised of at least one contextual exit order for exiting a financial position.

16. The method of claim 9, further comprising the step of offering at least one non-user created automated trading processes available for use to said user through said at least one automated trading computer.

17. A method of providing an automated trading system for financial market trading comprising:
providing a website on the Internet for access to said automated trading system;
providing an interface for a user, accessible from said website, to create at least one automatic trading process based upon at least one trigger point of at least one parameter
providing a process for automated monitoring of said at least one parameter;
providing a process for executing said at least one automated trading process when said at least one trigger point is obtained.

18. The method according to claim 17, further comprising the steps of:
processing said automated trading process against a plurality of historical data related to said at least one parameter to determine historical performance of said automated trading process.

19. The method according to claim 17, wherein said at least one parameter is related to foreign currency exchange trading.

20. The method according to claim 17, wherein said automated trading process is comprised of an entry order for entering a financial position.

21. The method according to claim 17, wherein said automated trading process is comprised of an exit order for exiting a financial position.

22. The method according to claim 17, where said automated trading process is comprised of an entry order for entering a financial position and an exit order for exiting a financial position.

23. The method according to claim 17, wherein said automated trading process is comprised of at least one contextual exit order for exiting a financial position.

24. The method of claim 17, further comprising the step of providing a process for offering at least one non-user created automated trading processes available for use by said user through said automatic trading system.
